(19) United States
(12) Patent Application Publication
(10) Pub. No.: US 2008/0155524 A1
(43) Pub. Date: Jun. 26, 2008

(54) Firmware Updating and Extending Method for Application Specific Integrated Circuit

(76) Inventors: Fuja Shone, Hsinchu (TW); Chi-Kuang Lu, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/616,019

(22) Filed: Dec. 26, 2006

(51) Int. Cl. G06F 9/44

(52) U.S. Cl. 717/168

(57) ABSTRACT

Without directly changing the fixed code masked in a read-only memory, the updatable code is stored in a programmable memory such as the flash memory in advance. When a corresponding procedure is to be executed, the updatable codes are first loaded into the random access memory. When the procedure is executed, the execution jumps to the random access memory for executing the updatable codes. Therefore, if a programmer would like to update the procedure, only updating the updatable code stored in the flash memory in advance is required.

### BACKGROUND OF THE INVENTION

1. Field of the Invention

The present invention relates to a firmware processing method, and more particularly, to a firmware updating and extending method for an application specific integrated circuit (ASIC).

2. Description of the Prior Art

In conventional application-specific integrated circuits, codes have to be masked in read-only memory for a boot up procedure of a corresponding operating system or for other procedures related to application programs after the boot-up processes have been executed. However, when program designers would like to update codes for the boot-up procedure or the application programs-related procedures for better execution or other design purposes, the program designers cannot update the codes masked in the read-only memory directly. Therefore, the program designers can only update the codes by taping out the mask on the read-only memory for generating new read-only memory having updated code for updating the boot-up procedure or updating the application programs-related procedures. The updated codes may merely have little difference with the codes masked in the old read-only memory, and taping out the mask for generating new read-only memory having updated code is obviously expensive and time-consuming.

### SUMMARY OF THE INVENTION

The claimed invention provides a firmware updating and extending method for an application specific integrated circuit. The method comprises providing read only memory (ROM) and random access memory, writing an updated code into the random access memory, executing a certain address of firmware code stored in the read only memory, when executing a certain specific address of firmware code, jumping to the updated code stored in the random access memory, and after executing the updated code, jumping back to the firmware code stored in the read only memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of performing the updating of the firmware updating and extending method of the present invention while a corresponding ASIC boots up.

FIG. 2 is a diagram of performing the extending of the firmware updating and extending method of the present invention.

FIG. 3 is a flow chart of the firmware updating and extending method shown in FIG. 1 while the ASIC executes a boot up procedure.

FIG. 4 is a flow chart of the firmware updating and extending method shown in FIG. 2 while the operating system executes application programs for instant requirements of the ASIC.

### DETAILED DESCRIPTION

The present invention provides a code processing method, which is also a firmware updating and extending method, for updating and extending process codes without taping out a mask of read-only memory in firmware. The firmware updating and extending method takes advantages of a programmable memory such as flash memory. So the codes stored in the programmable memory can be conveniently updated, especially for codes stored in flash memory, which has high access efficiency. Besides, the firmware updating and extending method also takes advantages of random access memory (RAM) having the property of dynamic loading. Random access memory can temporarily store data according to instant requirements of a corresponding operating system, thereby random access memory is also utilized for temporarily and dynamically storing data or codes loaded from flash memory in the present invention.

The firmware updating and extending method of the present invention is simply introduced as follows. Unchangeable codes are masked in the read-only memory of the ASIC whereas changeable codes are pre-stored in the programmable memory such as a flash memory outside the ASIC. While a procedure to be updated is going to be executed by the ASIC, the updated codes related to the procedure and pre-stored in the flash memory are loaded into the random access memory. The procedure first executes unchangeable codes from the read-only memory. When the procedure executes at a specific address on the read-only memory, where an updated code relating to the specific address had been loaded to the random access memory, the procedure temporarily switches the execution to the random access memory for executing the updated code. Therefore, the procedure includes the updated code without changing unchangeable codes on the read-only memory. The aim of the firmware updating and extending method of the present invention is thus fulfilled.

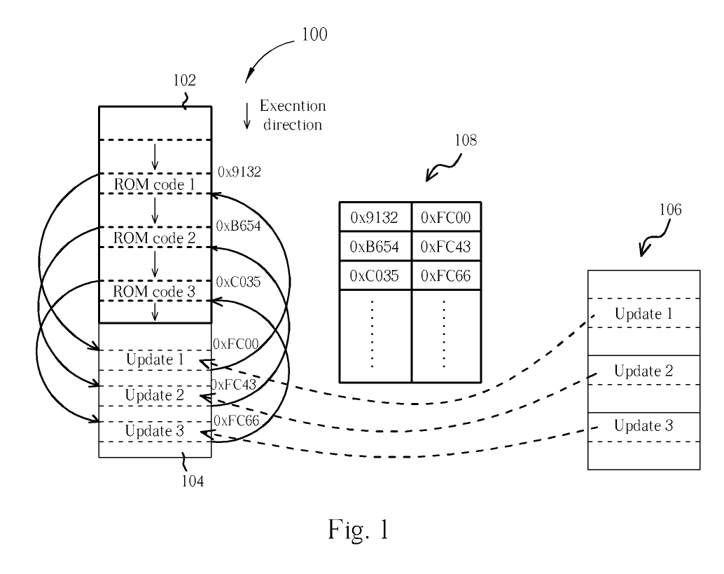

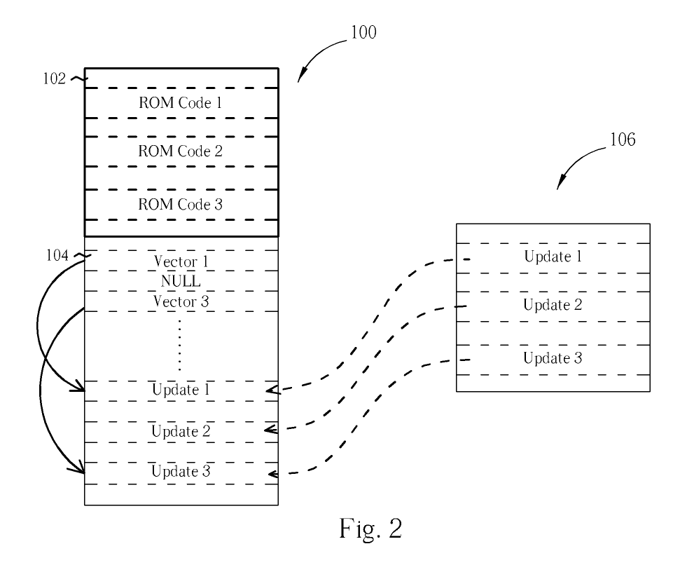

Details of the firmware updating and extending method of the present invention are described as follows. In FIG. 1, the firmware updating and extending method related to a boot up procedure of the ASIC is first introduced. In FIG. 2, the firmware updating and extending method related to executing application programs for instant requirements of the ASIC is introduced.

Please refer to FIG. 1, which is a diagram of performing the firmware updating and extending method of the present invention while a corresponding ASIC boots up. As shown in FIG. 1, program memory 100 comprises a read-only memory 102 and a random access memory 104. A flash memory 106 is provided for storing the updated code utilized for updating code of various procedures. A code replacement table 108 is utilized for storing mappings between the program memory 100 and the flash memory 106, and a mapping comprises a source address and a target address. The source address and the target address of a mapping may belong to the read-only memory 102 or the random access memory 104 of the program memory 100, or may belong to the flash memory 106.

The firmware updating and extending method classifies codes into two types. One type of code is regarded as fixed codes, which cannot be updated under any circumstances. The fixed codes are masked in read-only memory 102 since code stored in read-only memory cannot be changed or updated. As shown in FIG. 1, the codes “ROM code 1”, “ROM code 2”, “ROM code 3” are all fixed codes stored in the read-only memory 102. Another type of codes is regarded as updatable codes, which can be updated under instant requirements of the ASIC. The updatable codes are primarily stored in the flash memory 106 for dynamic loading by the ASIC. As shown in FIG. 1, the codes “Update 1”, “Update 2”, “Update 3” are all updatable codes stored in the flash memory 106, and are utilized for replacing the fixed codes “ROM code 1”, “ROM code 2”, “ROM code 3” during the boot up procedure. The property that the codes stored in the flash memory 106 can be dynamically updated is utilized so that programmers may freely put updatable codes into the flash memory 106 for being loaded by the ASIC at any time. Note that the codes stored in the flash memory 106 may be programmed with respect to various procedures executed by the operating system of the ASIC.

The random access memory 104 of the program memory 100 is utilized for dynamically loading codes from the flash memory 106 according to various instant requirements of the operating system or various procedures to be executed by the operating system. As shown in FIG. 1, the updatable codes “Update 1”, “Update 2”, “Update 3” are loaded from the flash memory 106 to the random access memory 104. The size of the random access memory 104 is smaller than the size of the read-only memory 102, and the random access memory 104 occupies more area per unit than the read-only memory 102, i.e., the random access memory 104 stores more data per unit than the read-only memory 102. However, without a power supply, the random access memory 104 cannot keep stored code whereas the read-only memory 102 can keep stored code without the power supply. Therefore, even if the random access memory 104 stores more data per unit than the read-only memory 102, the read-only memory 102 is utilized for storing fixed code, and the random access memory 104 is utilized for dynamically loading updatable code according to instant requirements. The random access memory 104 can be implemented with conventional static random access memory (SRAM) or dynamic random access memory (DRAM).

The code replacement table 108 is utilized for storing mappings for supporting dynamic loading between the read-only memory 102 and the random access memory 104. Each mapping of the mappings stored in the code replacement table 108 comprises a source address of the read-only memory 102 and a target address of the random access memory 104, thereby, while the operating system executes a fixed code at the source address of the read-only memory 102, the operating system can immediately jump the execution to the updatable code stored at the target address of the random access memory 104 by querying the mapping comprising the source address and the target address. As shown in FIG. 1, while the boot up procedure executes at a source address “0x9132”, where the code “ROM code 1” begins, the operating system queries the code replacement table 108 and retrieves the target address “0xFC00” of the random access memory 104. Then the operating system jumps the execution from the source address “0x9132” to the target address “0xFC00” for executing the updatable code “Update 1”. After the updatable code “Update 1” is executed, the execution jumps back to where the fixed code “ROM code 1” ends in the read-only memory 102 as shown in FIG. 1. However, the execution may also jump to other positions on the read-only memory 102, meaning that after the updatable code “Update 1” is executed, the position where the execution then jumps to is not limited by what shown in FIG. 1.

Before the ASIC boots up, the operating system first loads updatable code of processes related to the boot up procedure from the flash memory 106 to the random access memory 104. Since the updatable codes stored in the flash memory 106 are classified according to various procedures in advance, the operating system can rapidly load necessary updatable code from the flash memory 106. As shown in FIG. 1, the updating codes “Update 1”, “Update 2”, and “Update 3” were previously stored in the flash memory 106, and before the boot up procedure begins, the updating codes “Update 1”, “Update 2”, and “Update 3” are loaded into the random access memory 104. Then the operating system generates necessary mappings to the code replacement table 108, each one of the mappings having a source address of the read-only memory 102 and a target address of the random access memory 104 as mentioned above.

While the ASIC boots up, the operating system belonging to the ASIC starts sequentially executing the fixed codes related to the boot up procedure and stored in the read-only memory 102. At the same time, the operating system monitors the mappings stored in the code replacement table 108 for jumping the execution from the read-only memory 102 to the random access memory 104. When the operating system executes at a source address of the read-only memory 102, the source address matching with a mapping of the code replacement table 108, the operating system jumps the execution from the source address of the read-only memory 102 to a target address of the random access memory 104 according to the matched mapping. Then the operating system executes the updatable code at the target address of the random access memory 104. After finishing executing the updatable code in the random access memory 104, the execution directly jumps back to the source address of the read-only memory 102 or a next address of the read-only address 102. When there is a plurality of mappings corresponding to the boot up procedure in the code replacement table, it indicates that there is a corresponding plurality of jumps in the program memory 100.

When the programmer would like to update the updatable code again so that the updated updatable code can be loaded into a next-time boot up procedure, the programmer only needs to store new codes corresponding to the boot-up procedure into the flash memory 106, and when a next-time boot up procedure begins, the new codes will be executed by the operating system as mentioned above. Therefore, updating the updatable code is simply finished by updating the code stored in the flash memory 106.

The method can be easily used for skipping some block of codes in the read only memory by setting both the source and target addresses in the ROM codes. Therefore, when the source address is reached, the execution automatically jumps to the target address so that the block of codes is skipped.

Please refer to FIG. 2, which is a diagram of performing the extending of the firmware updating and extending method of the present invention. The arrangement of the codes shown in FIG. 2 is somewhat different than the arrangement in FIG. 1 since the boot up procedure is performed just like in FIG. 1 while a plurality of application subroutines (or procedures) could be replace dynamically depending on the various conditions that the ASIC chip will cooperate. For example, in FIG. 2, there are 3 pre-determined firmware code address, “ROM code 1”, “ROM code 2”, and “ROM code 3” in the read-only memory 102, and there are three updatable codes “Update 1”, “Update 2”, and “Update 3” stored into the flash memory 106. Note that the updatable code “Update 1” corresponds to the first procedure at the fixed code address “ROM code 1”, the updatable code “Update 2” corresponds to the second procedure at the fixed code address “ROM code 2”, the updatable code “Update 3” corresponds to the third procedure at the fixed code address “ROM code 3”.

After the ASIC boots up, the firmware code itself of the ASIC loads the three updatable codes from the flash memory 106 to the random access memory 104 as shown in FIG. 2. Then the firmware code prepares three columns respectively corresponding to the three procedures in the random access memory 104 for linking the updatable codes to the existing firmware code in the ASIC. As shown in FIG. 2, the value of a first column may be NULL or a vector “Vector 1” corresponding to the first procedure according to whether the first procedure needs to be executed under the current specific condition. Similarly, the value of a second column may be NULL or a vector “Vector 2” corresponding to the second procedure, and the value of a third column may be NULL or a vector “Vector 3” corresponding to the third procedure. The function of the vectors is similar to the function pointers.

While the first procedure is going to be executed with the updatable code “Update 1”, the vector “Vector 1” is put into the first column for dynamically executing the updatable code “Update 1” since the vector “Vector 1” is able to explicitly point to the location of the updated code “Update 1” in the random access memory 104. Therefore, the functions of the vectors make the updated code easily replaced. Please refer to FIG. 2, when the first procedure and the third procedure are going to be executed, thereby, only the vectors “Vector 1” and “Vector 3” are put into the random access memory 104 while the second column is filled with the value NULL. While a procedure is to be updated, for example, the first procedure, the programmer may simply update the updatable code “Update 1” in the flash memory 106. Next time when the first procedure is executed, the updated updatable code is thus executed, and the aim of updating code corresponding to a specific procedure is easily achieved. Similarly, the arrangement of the codes shown in FIG. 2 may also be utilized in the boot up procedure shown in FIG. 1 and is not limited to the code arrangement shown in FIG. 1. The firmware updating and extending method shown in FIG. 2 is merely a preferred embodiment for the ASIC executing a plurality of procedures dynamically in the present invention.

The number of procedures that the firmware updating and extending method utilized in FIG. 2 can process is not limited to three procedures as shown in FIG. 2. It means that the number of procedures that the firmware updating and extending method utilized in FIG. 2 can also process fewer or more than three procedures according to the capability of the ASIC.

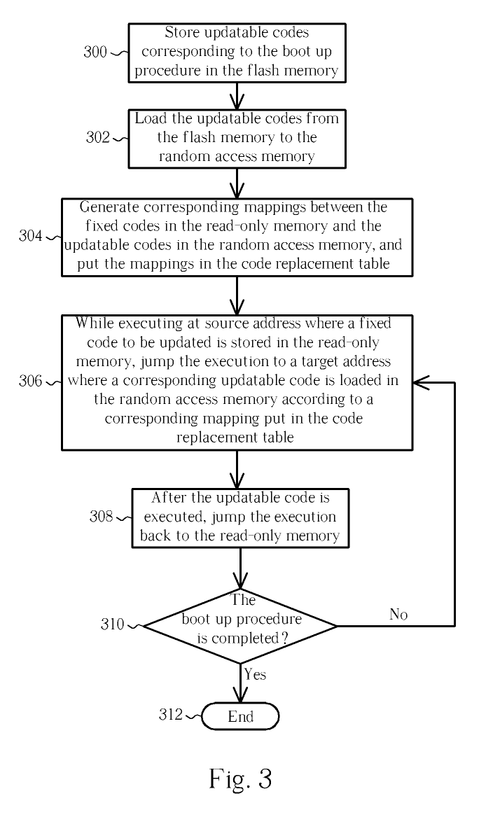

Please refer to FIG. 3, which is a flow chart of the firmware updating and extending method shown in FIG. 1 while the ASIC executes a boot up procedure. The firmware updating and extending method shown in FIG. 1 comprises the following steps:

Step 300: Storing updatable codes corresponding to the boot up procedure in the flash memory.

Step 302: Loading the updatable codes from the flash memory to the random access memory.

Step 304: Generating corresponding mappings between the fixed codes in the read-only memory and the updatable codes in the random access memory and putting the mappings in the code replacement table.

Step 306: While executing at source address where a fixed code to be updated is stored in the read-only memory, jumping the execution to a target address where a corresponding updatable code is loaded in the random access memory according to a corresponding mapping put in the code replacement table.

Step 308: After the updatable code is executed, jumping the execution back to the read-only memory.

Step 310: Check if the boot up procedure is completed.

Step 312: End.

The steps Step 300, 302, and 304 are performed for preparation before the boot up procedure is executed. The steps 306, 308, and 310 are performed repeatedly until the boot up procedure is completed in step 310 since there may be a plurality of fixed codes to be updated in the read-only memory.

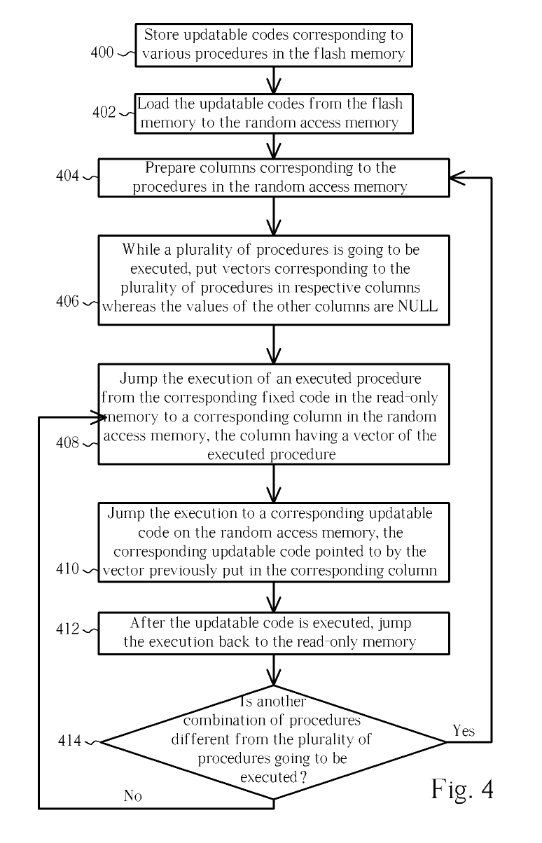

Please refer to FIG. 4, which is a flow chart of the firmware updating and extending method shown in FIG. 2 while the operating system executes application programs for instant requirements of the ASIC. The firmware updating and extending method shown in FIG. 2 comprises the following steps:

Step 400: Storing updatable codes corresponding to various procedures in the flash memory.

Step 402: Loading the updatable codes from the flash memory to the random access memory.

Step 404: Preparing columns corresponding to the procedures in the random access memory.

Step 406: While a plurality of procedures is going to be executed, putting vectors corresponding to the plurality of procedures in respective columns whereas the values of the other columns are NULL.

Step 408: Jumping the execution of an executed procedure from the corresponding fixed code in the read-only memory to a corresponding column in the random access memory, the column having a vector of the executed procedure.

Step 410: Jumping the execution to a corresponding updatable code on the random access memory, the corresponding updatable code is pointed to by the vector previously put in the corresponding column.

Step 412: After the updatable code is executed, jumping the execution back to the read-only memory.

Step 414: Go to Step 404 when another combination of procedures different from the plurality of procedures is going to be executed, else, go to Step 408.

The steps Step 400, 402, 404, and 406 are performed for preparation before a plurality of procedures is going to be executed after the boot up procedure of the ASIC is completed. The steps 408, 410, 412, and 414 are performed repeatedly for instant requirements of the ASIC until a different set of updated procedures is needed. This means that the combination of procedures to be executed varies instantly according to instant requirements of the ASIC, and one combination of procedures to be executed corresponds to a single iteration of the steps 408, 410, 412, and 414.

The firmware updating and extending method of the present invention provides an easier way for updating codes of procedures in firmware using flash memory. The properties of large storage and easy updating in the flash memory are utilized. The property of rapid access in the random access memory is also utilized. By loading the updatable codes from the flash memory to the random access memory in advance, the operating system of the ASIC can easily access and execute the updatable codes, which have been updated with respect to the procedures in the firmware, and the procedures may be easily updated by executing the updated updatable codes. Therefore, even if the fixed code masked in the read-only memory cannot be updated, by updating the updatable codes, the aim of updating the procedures without changing the codes in the read-only memory of the present invention is easily fulfilled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware updating and extending method for an application specific integrated circuit, the method comprising:
providing read only memory (ROM) and random access memory;
writing an updated code into the random access memory;
executing a specific address of firmware code stored in the read only memory;
when executing the specific address of the firmware code, jumping to the updated code stored in the random access memory; and
after executing the updated code, jumping back to the firmware code stored in the read only memory.

2. The method of claim 1 wherein writing the updated code into the random access memory is before booting up a ASIC, writing the updated code into the random access memory.

3. The method of claim 1 wherein jumping back to the firmware code stored in the read only memory is executing the firmware code stored in the read only memory to complete a boot up process.

4. The method of claim 1 wherein providing the random access memory is providing static random access memory.

5. The method of claim 1 wherein providing the random access memory is providing dynamic random access memory.

6. The method of claim 1 wherein executing a certain address of the firmware code is executing the certain address of the firmware code while monitoring a code replacement table which indicates an end address of the firmware code, and an initial address of the updated code.

7. The method of claim 1 further reading the updated code from flash memory.

8. The method of claim 1 wherein providing the read only memory and the random access memory is providing the read only memory and the random access memory which has a memory size smaller than the read only memory.

9. The method of claim 1 wherein writing the updated code into the random access memory is writing the updated code into the random access memory while executing the firmware code.

10. The method of claim 1 wherein executing the certain address of firmware code stored in the read only memory is executing the certain address of the firmware code stored in the read only memory while executing an application program.

11. The method of claim 1 wherein executing the certain address of firmware code stored in the read only memory is executing the certain address of firmware code stored in the read only memory while executing a process.
